(19) United States
(12) Patent Application Publication
(10) Pub. No.: US 2006/0249598 A1
(43) Pub. Date: Nov. 9, 2006

(54) Spray head for liquid product

(75) Inventors: Arnaud Helie, La Saussaye (FR); Wilfrid Beaujour, Darnetal (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S, Neubourg (FR)

(21) Appl. No.: 10/566,708

(22) PCT Filed: Jul. 27, 2004
(86) PCT No.: PCT/FR04/02006

§ 371 Date: Mar. 1, 2006

(30) Foreign Application Priority Data
Aug. 8, 2003 (FR) 03/09797

(51) Int. Cl. B05B 1/34

(52) U.S. Cl. 239/494; 239/596

(57) ABSTRACT

A fluid spray head comprising an expulsion channel (5) provided with a spray orifice (1) and a spray profile (10) formed in an end wall of said spray head, said spray profile (10) comprising preferably non-radial spray channels (11) opening out to a central spray chamber (12) disposed directly upstream from said spray orifice (1), an insert (20) being disposed in said expulsion channel (5) so as to form a cover for said spray profile (10), the central axis (X) of said insert (20) being substantially identical to the central axis (Y) of said expulsion channel (5), and said spray head including centering means for centering said insert (20).

The present invention relates to a fluid spray head.

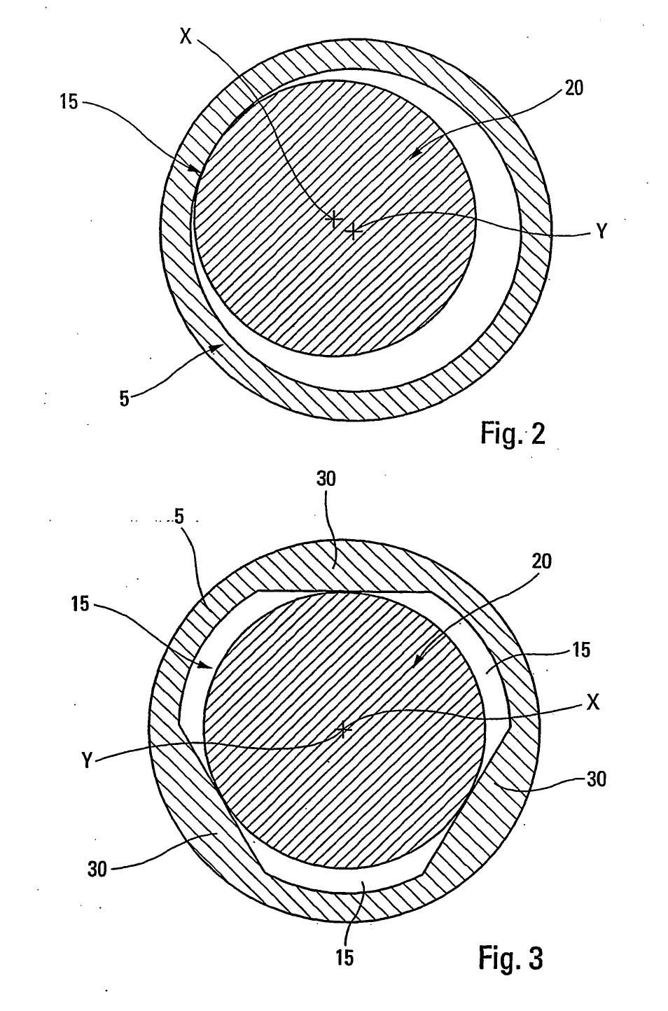

Fluid dispenser heads are well known, in particular in the field of pharmacy. In order to dispense a fine spray, the head generally includes a spray profile disposed just upstream from the spray orifice. The spray profile can be formed by an external part, known as an external nozzle, fastened on the outside, as described in documents U.S. Pat. No. 3,625,437, EP-0 906 785, FR-1 355 350, and EP-0 412 524. That solution presents the major drawback of a risk of said nozzle being expelled during use. In order to mitigate that drawback, it is proposed to make the spray profile by means of an insert that is inserted into the head through the inside of said head, said insert forming the end wall of said spray profile and limiting the dead volume. The characteristics of the spray, in particular the size distribution of the droplets and the reproducibility of such characteristics, are largely dependent on the shape of said spray profile. It turns out that in most fluid dispenser devices, in particular of medicines, the performance is not very consistent because of manufacturing tolerances during molding of the head. In particular, this results in the central axis of the orifice of the insert being offset from the central axis of the spray chamber. Such offset, shown in FIG. 2, can result in the spray profile being asymmetrical, with access to one of the non-radial channels being practically blocked. As a result, the fluid does not swirl as much in the spray chamber, and the performance and characteristics of the spray are thus affected. Such offset of the axes can be substantial, and can in particular vary greatly from one head to another. This prevents consistent spray characteristics from being obtained.

An object of the present invention is to provide a fluid spray head that does not have the above-mentioned drawbacks.

More particularly, an object of the present invention is to provide a fluid spray head that is safe and reliable and that has fluid spray characteristics and performance that are consistent and reproducible for any head coming from a common mold cavity.

Another object of the present invention is to provide a fluid spray head that is simple and inexpensive to manufacture and to assemble.

The present invention thus provides a fluid spray head comprising an expulsion channel provided with a spray orifice and a spray profile formed in an end wall of said spray head, said spray profile comprising preferably non-radial spray channels opening out to a central spray chamber disposed directly upstream from said spray orifice, an insert being disposed in said expulsion channel so as to form a cover for said spray profile, the central axis of said insert being substantially identical to the central axis of said expulsion channel, and said spray head including centering means for centering said insert.

Advantageously, said expulsion channel includes said centering means for centering said insert.

Advantageously, said centering means comprise at least one projection, and preferably three, the diameter of the inscribed circle defined by said projections being substantially identical to the diameter of the insert.

Advantageously, the expulsion channel includes three flat surfaces that are distributed symmetrically about said channel, said flat surfaces co-operating with said insert so as to center it relative to said expulsion channel.

Advantageously, the accesses of the expulsion channel to the spray channels are formed between said projections.

Advantageously, the central axis of said insert is offset from the central axis of the expulsion channel by a distance that is less than 0.08 mm, and preferably less than 0.03 mm.

Advantageously, said spray chamber has a diameter of 1 mm.

Advantageously, said spray orifice has a diameter of 0.3 mm.

The present invention also provides a set of spray heads manufactured from a common mold cavity, said heads being made as described above.

Advantageously, the standard deviation of the offset of the central axis of the insert relative to the central axis of the expulsion channel for any spray head coming from a common mold cavity is less than 0.05 mm, and advantageously less than 0.02 mm.

The present invention also provides a fluid dispenser device including a head as described above.

Other characteristics and advantages of the present invention appear more clearly from the following detailed description of an advantageous embodiment thereof, given by way of non-limiting example, and with reference to the accompanying drawings, and in which:

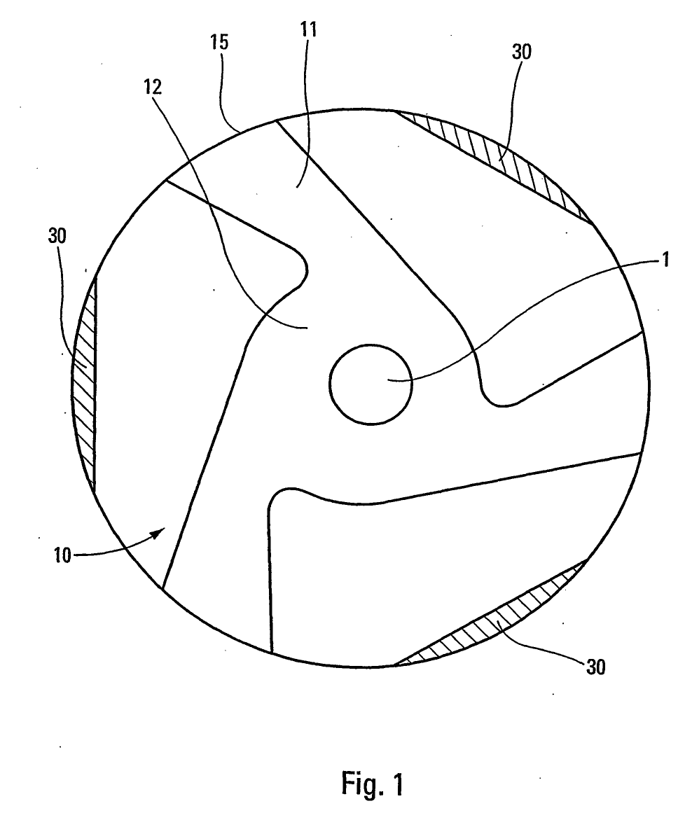

FIG. 1 is a diagrammatic view in horizontal section through the spray profile of a dispenser head of the present invention;

FIG. 2 is a diagrammatic view in horizontal section through the expulsion channel of a prior-art spray head; and

FIG. 3 is a diagrammatic view in horizontal section through the expulsion channel of a spray head constituting an embodiment of the present invention.

The present invention applies to any type of fluid spray head. However, the present description is made with reference to an elongate head, e.g. a nasal dispenser head, including a spray orifice directed along the axis of the head. Naturally, the present invention could apply to any type of head, and in particular heads in which the spray is dispensed transversally.

In the invention, the fluid spray head includes an expulsion channel 5 that is provided with a spray orifice 1 and with a spray profile 10 that is disposed upstream from said spray orifice 1. The spray profile 10 is formed in the end wall of the spray head, and, in known manner, comprises preferably non-radial spray channels 11 leading into a central spray chamber 12 disposed directly upstream from said spray orifice 1. The channels can be three in number, as shown in FIG. 1, but some other configuration can be envisaged. An insert 20, that is preferably solid and of simple shape similar to a rod, is provided in said expulsion channel 5 so as to limit the dead volume and form a cover for said spray profile 10. The insert 20 is inserted through the inside of the head and thus forms an internal nozzle which, in contrast to an external nozzle fastened on the outside of the head, does not risk being expelled during actuation. Thus, the fluid flowing along the expulsion channel 5 and around said insert via the access 15 reaches the non-radial channels 11 in front of the front face of said insert. The fluid then swirls into the spray chamber 12 before being expelled through the spray orifice 1 in the form of spray. The device of the invention is thus formed of only two parts, an external part forming the head, and an internal part forming the insert.

The present invention is characterized by the fact that, as far as possible, the central axis X of the insert 20 is identical to the central axis Y of the expulsion channel 5.

To do this, centering means are provided for the insert 20. The centering means are preferably formed in the expulsion channel 5, in the proximity of said spray profile 10. They can comprise one or more projections adapted to co-operate with the insert 20 so as to center it. FIG. 3 shows an advantageous embodiment in which the expulsion channel 5 includes three flat surfaces 30 that are evenly distributed around the channel. The projections define an inscribed circle having a diameter that corresponds approximately to the diameter of the insert 20. In this way, by placing the flat surfaces 30 between the accesses 15 to the non-radial channels 11 of the spray profile 10, while the insert 20 is being assembled, the insert 20 is prevented from closing off one of the accesses 15, as shown in FIG. 2 for the prior-art head. The flat surfaces could be replaced by different profiles, such as convex or concave projections, e.g. circular arcs, or even by a plurality of lugs distributed around the channel. Since the insert 20 is centered, the fluid flows in approximately equal manner through the three channels 11, and a good spray is formed with optimum spray characteristics both in terms of performance (average size of droplets and droplet size distribution) and in terms of consistency (reproducibility of performance for any head). Naturally, the manufacturing tolerances of the expulsion channel 5 and of the insert 20 can cause the axes X and Y to be a little offset, but the flat surfaces 30 make it possible to limit such offset. Such offset is advantageously less than 0.08 mm, and preferably less than 0.03 mm. In addition, by means of the present invention, spray heads coming from a common mold cavity present a standard deviation for the offset of the central axis X of the insert relative to the central axis Y of the expulsion channel, that is less than 0.05 mm, and preferably less than 0.02 mm. The relatively small offset values, together with the standard deviation that is much smaller than the standard deviation that currently exists, make it possible to improve the quality of the spray.

A particularly advantageous embodiment relates to a dispenser head in which the spray chamber 12 has a diameter of about 1 mm, and the spray orifice 1 has a diameter of about 0.3 mm.

The present invention thus makes it possible to improve fluid dispenser heads by improving the characteristics and the performance of the spray that it dispenses, and also improving the consistency of those characteristics.

Although the present invention is described above with reference to a particular embodiment thereof, it is clear that it is not limited by said embodiment. On the contrary, any useful modifications can be applied thereto by the person skilled in the art, without going beyond the ambit of the present invention, as defined by the accompanying claims.

1. A fluid spray head comprising an expulsion channel (5) provided with a spray orifice (1) and a spray profile (10) formed in an end wall of said spray head, said spray profile (10) comprising preferably non-radial spray channels (11) opening out to a central spray chamber (12) disposed directly upstream from said spray orifice (1), an insert (20) being disposed in said expulsion channel (5) so as to form a cover for said spray profile (10), the central axis (X) of said insert (20) being substantially identical to the central axis (Y) of said expulsion channel (5), said spray head including centering means for centering said insert (20), the spray head being characterized in that said expulsion channel (5) includes said centering means for centering said insert (20), and in that said centering means are formed in the proximity of the spray profile (10).

2. A head according to claim 1, in which said centering means comprise at least one projection (30), and preferably three, the diameter of the inscribed circle defined by said projections being substantially identical to the diameter of the insert (20).

3. A head according to claim 2, in which the expulsion channel (5) includes three flat surfaces (30) that are distributed symmetrically about said channel, said flat surfaces (30) co-operating with said insert (20) so as to center it relative to said expulsion channel (5).

4. A head according to claim 2, in which the accesses of the expulsion channel (5) to the spray channels (11) are formed between said projections.

5. A head according to claim 1, in which the central axis (X) of said insert (20) is offset from the central axis (Y) of the expulsion channel (5) by a distance that is less than 0.08 mm, and preferably less than 0.03 mm.

6. A spray head according to claim 1, in which said spray chamber (12) has a diameter of 1 mm.

7. A spray head according to claim 1, in which said spray orifice (1) has a diameter of 0.3 mm.

8. A set of spray heads manufactured from a common mold cavity, the set being characterized in that said heads are made according to claim 1.

9. A set according to claim 8, in which the standard deviation of the offset of the central axis (X) of the insert (20) relative to the central axis (Y) of the expulsion channel (5) for any spray head coming from a common mold cavity is less than 0.05 mm, and advantageously less than 0.02 mm.

10. A fluid dispenser device characterized in that it includes a spray head according to claim 1.
